(19) United States
(12) Patent Application Publication
(10) Pub. No.: US 2017/0099229 A1
(43) Pub. Date: Apr. 6, 2017

(54) RELAY DEVICE AND RELAY METHOD

(71) Applicant: FUJITSU LIMITED, Kawasaki-shi (JP)

(72) Inventor: Junichi Suga, Ota (JP)

(73) Assignee: FUJITSU LIMITED, Kawasaki-shi (JP)

(21) Appl. No.: 15/284,626

(22) Filed: Oct. 4, 2016

(30) Foreign Application Priority Data
Oct. 6, 2015 (JP) 2015-198694

(51) Int. Cl. H04L 12/825; H04L 12/801; H04L 12/815; H04L 12/26

(52) U.S. Cl. CPC H04L 47/25; H04L 43/16; H04L 43/0829; H04L 43/0894; H04L 47/19; H04L 47/22

(57) ABSTRACT

A relay device including a memory, and a processor coupled to the memory and the processor configured to perform communication of a packet with a communication device via a first communication session, perform communication of a packet with the communication device via a second communication session established before the first communication session, and perform a first control or a second control for the first communication session and the second communication session, the first control including decreasing a bandwidth of the second communication session when a packet loss is detected in the first communication session, the second control including increasing a bandwidth of the first communication session when a reception acknowledgement response for transmission of the packet is detected in the second communication session.

### CROSS-REFERENCE TO RELATED APPLICATION

This application is based upon and claims the benefit of priority of the prior Japanese Patent Application No. 2015-198694, filed on Oct. 6, 2015, the entire contents of which are incorporated herein by reference.

### FIELD

The embodiments discussed herein are related to a relay device and a relay method.

### BACKGROUND

In 3rd Generation Partnership Project (3GPP) serving as a standardization body, specifications of a Long Term Evolution (LTE) system and a LTE-Advanced (LTE-A) system based on the LTE are currently studied. Regarding the LTE, LTE Release 8 to Release 12 are developed as international specifications. In addition, LTE Release 10 and the international specifications subsequent thereto are also called LTE-Advanced.

In the LTE, communication is performed via a mobile network called an evolved packet core (EPC). A terminal called a user equipment (UE) accesses a server via a base station called an evolved Node B (eNB) and the EPC. From this, the terminal is able to receive various services such as a Web browsing service and video streaming.

In the LTE, a packet data network (PDN) gateway (P-GW) is installed at a connection point between the EPC and an external network. The P-GW establishes bearers with respective terminals. The term “bearer” means a logical line through which, for example, user data and so forth are transmitted. In a line in which the bearer is set, for example, a specific level of quality of service (QoS) is secured. The bearer is able to be established for QoS classes according to the standardized specification of the 3GPP. However, actually, a dedicated bearer (hereinafter, called an “individual bearer” in some cases) is used for voice communication and a bearer called default bearer is used for communication other than the voice, in some cases.

On the one hand, in the 3GPP, technologies of local breakout, such as local IP access (LIPA) and selected IP traffic offload (SIPTO), which are each capable of accessing a server via no EPC, are currently studied. The term “local breakout” means, for example, a technology for accessing a server in the Internet via no mobile core network such as the EPC. From this, a terminal is able to directly access a server in the Internet via no EPC, and it becomes possible to achieve reduction of a traffic amount in, for example, the EPC.

On the other hand, a technology of congestion control is used for communication in some cases. The term “congestion control” means a technology for adjusting a congestion window corresponding to, for example, the transmission amount of packets. Every time, for example, the Web browsing service or a mail service is performed, a connection (hereafter, called a TCP session in some cases) based on a transmission control protocol (TCP) is established, and the congestion control is performed for each of TCP sessions. Based on the congestion control, it becomes possible to inhibit congestion from occurring in communication via a TCP session.

As technologies related to communication, there are the following technologies, for example. In other words, there is a communication device that manages, for pieces of address information, respective pieces of reception window information to serve as data sizes receivable by an opposite communication device and that transmits data to the opposite communication device by using, based on the pieces of reception window information, one of the pieces of address information. According to this technology, it is said that even if congestion occurs in a specific line at a time of establishment of an association of multihoming, it is possible to enable transmission and reception of a data channel.

In addition, there is a network relay device that increases a bandwidth of a packet transfer unit until a TCP connection is established after reception of a SYN packet if the SYN packet is received in a case where a control unit performs transfer performance improvement processing and transfer performance degradation processing. According to this technology, it is said that, in a network relay device, it is possible to realize low power consumption while suppressing an occurrence of a packet loss.

Furthermore, there is a band management device that performs control for discarding an arriving cell or inputting it into a FIFO, depending on whether or not input cell rates of respective connections exceed respective virtual MCR values obtained by assigning allocated bands of a free band of the FIFO to minimum cell rate (MCR) values for the respective connections. According to this technology, it is said that it is possible to provide a device that evenly allocates the free band to the individual connections in an asynchronous communication network and that enables network resources to be more efficiently used.

As technologies of the related art, there are Japanese Laid-open Patent Publication No. 2013-223234, Japanese Laid-open Patent Publication No. 2010-147744, and Japanese Laid-open Patent Publication No. 2000-31997.

Furthermore, as a technology of the related art, there is “Local IP Access and Selected IP Traffic Offload (LIPA-SIPTO) (Release 10)”, 3GPP TR 23.829, V10.0.1 (2011-10).

### SUMMARY

According to an aspect of the invention, a relay device including a memory, and a processor coupled to the memory and the processor configured to perform communication of a packet with a communication device via a first communication session, perform communication of a packet with the communication device via a second communication session established before the first communication session, and perform a first control or a second control for the first communication session and the second communication session, the first control including decreasing a bandwidth of the second communication session when a packet loss is detected in the first communication session, the second control including increasing a bandwidth of the first communication session when a reception acknowledgement response for transmission of the packet is detected in the second communication session.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a communication system;

FIG. 2 is a diagram illustrating an example of a configuration of the communication system;

FIG. 3 is a diagram illustrating an example of a configuration of a GW;

FIG. 4A and FIG. 4B are diagrams illustrating examples of a default bearer and an individual bearer, respectively;

FIG. 5A and FIG. 5B are diagrams illustrating examples of TFT information and filtering information, respectively;

FIG. 6 is a diagram illustrating an example of a configuration of a TCP proxy;

FIG. 7 is a diagram illustrating examples of parameters;

FIG. 8 is a diagram illustrating an example of congestion control;

FIG. 9 is a flowchart illustrating an example of an operation;

FIG. 10 is a diagram illustrating examples of congestion windows in respective 2 TCP sessions;

FIG. 11 is a diagram illustrating an example of congestion control;

FIG. 12 is a sequence diagram illustrating an example of an operation;

FIG. 13 is a diagram illustrating examples of congestion windows in respective 2 TCP sessions; and

FIG. 14 is a diagram illustrating an example of a configuration of each of a GW, a terminal, or a server.

### DESCRIPTION OF EMBODIMENTS

In a case where a Web access, mail transmission, or the like is newly performed in, for example, a terminal device, a new TCP session is established for an existing TCP session established. The new TCP session is a TCP session generated by an operation performed on the terminal device by a user and may be said to be communication prioritized over communication via the existing TCP session.

However, in the new TCP session, a throughput thereof is not increased, in some cases. As the reasons therefor, for example, there are the following 2 reasons.

As a first reason, there is a point that first slow start is initiated in a case where congestion control is to be performed on the new TCP session. The slow start is congestion control in which a congestion window is set to, for example, a minimum value and after that, the congestion window is increased every time a reception acknowledgement response (or acknowledgement (ACK)) is received from a receiving side. There is an aspect that since, at a time of initiating the slow start, the congestion window is smaller than that after the slow start is initiated and the transmission amount of packets is small, it is difficult for the throughput of the new TCP session to be increased.

As a second reason, there are communication resources of a bearer. Communication resources available in one entire bearer are finite. If a new TCP session is initiated in a state in which an existing TCP session contained in the bearer utilizes the communication resources of the entire bearer, utilization of the communication resources of the bearer for the new TCP session is in some cases. In a case where the new TCP session just utilizes, for example, a small amount of communication resources, if a packet loss or the like occurs, the congestion window in the congestion control is reduced to a predetermined value. The reduction of the congestion window impedes an increase in the throughput of the new TCP session.

The above-mentioned technology for managing the pieces of reception window information of the respective pieces of address information does not provide a solution to a case where congestion occurs in a specific line and the throughput of the new TCP session is not increased while it is possible to transmit and receive data channels.

The above-mentioned technology for increasing the bandwidth of the packet transfer unit until the TCP connection is established after reception of the SYN packet does not provide a solution to a case where the throughput of the new TCP session is not increased after the TCP connection establishment. The technology for discarding the arriving cell or inputting it into the FIFO, depending on whether or not the virtual MCR values are exceeded, argues nothing about a throughput for the new TCP session.

Therefore, one disclosure is to provide a relay device and a relay method, which each immediately increase the throughput of a new communication session.

In addition, one disclosure is to provide a relay device and a relay method, which each increase the throughput of communication desired by a user.

Hereinafter, embodiments for implementing the present technology will be described. Note that the following examples do not limit the disclosed technology. In addition, the individual embodiment may be arbitrarily combined insofar as contents of processing operations do not contradict one another.

### First Embodiment

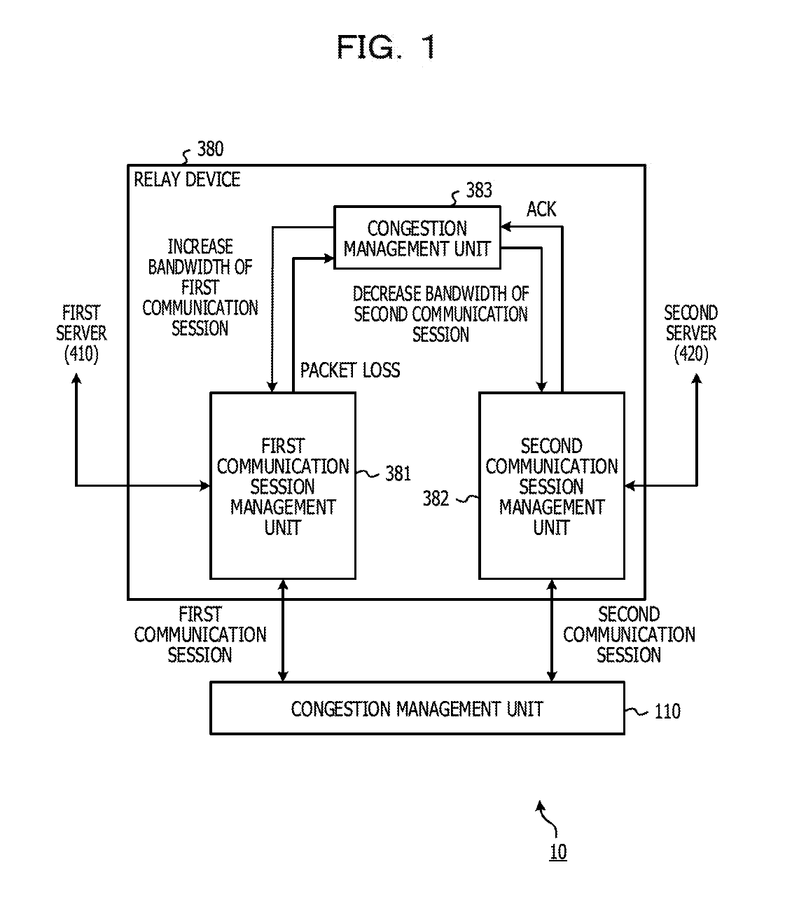

FIG. 1 is a diagram illustrating an example of a configuration of a communication system 10 in the present first embodiment. The communication system 10 includes a relay device 380 and a communication device 110. In this regard, however, the communication system 10 may include first and second servers 410 and 420 serving as communication destinations of the communication device 110.

The relay device 380 relays packets transmitted and received in, for example, 2 communications performed between the communication device 110 and the first server 410 and between the communication device 110 and the second server 420.

The relay device 380 includes a first communication session management unit 381, a second communication session management unit 382, and a congestion management unit 383.

The first communication session management unit 381 establishes a first communication session with the communication device 110 and performs communication of packets with the communication device 110 via the first communication session. In this case, the first communication session management unit 381 performs congestion control for transmission of packets via the first communication session. At a time of the congestion control, the first communication session management unit 381 performs the transmission of packets via the first communication session while increasing the bandwidth of the first communication session. A congestion window indicates a data amount of bandwidth of, for example, transmittable packets. In what follows, for example, the congestion window and the bandwidth are interchangeably used in some cases. In addition, in a case of increasing the bandwidth of the first communication session, thereby transmitting packets, the first communication session management unit 381 is able to detect a packet loss.

The second communication session management unit 382 establishes a second communication session with the communication device 110 and performs communication of packets with the communication device 110 via the second communication session. In addition, in the second communication session management unit 382, congestion control is performed for transmission of packets via the second communication session established with the communication device 110. In this case, the second communication session management unit 382 performs the transmission of packets while increasing the bandwidth of the second communication session.

In a case where a packet loss is detected in the first communication session, the congestion management unit 383 decreases the bandwidth of the second communication session. In the second communication session management unit 382, based on the decreased bandwidth, communication of packets is performed with the communication device 110 via the second communication session.

Here, for example, a case where the first communication session is a new communication session and the second communication session is an existing communication session is considered. In this case, there is a possibility that the congestion management unit 383 decreases the bandwidth of the second communication session (the existing communication session), thereby increasing the bandwidth of, for example, the first communication session (the new communication session).

In a case where the bandwidth of the first communication session is increased, even if a packet loss is detected, it is possible to transmit packets in the new communication session, and the data amount thereof turns out to be increased. Accordingly, the relay device 380 becomes able to immediately increase the throughput of the new communication session user and is able to increase a communication throughput desired by a user.

On the other hand, after an initial packet loss is detected in the second communication session (the existing communication session), the second communication session management unit 382 is able to receive, in the second communication session, a reception acknowledgement response for transmission of packets. In a case where the second communication session management unit 382 receives the reception acknowledgement response, the congestion management unit 383 performs the following processing. In other words, the congestion management unit 383 increases the bandwidth of the first communication session (the new communication session). The first communication session management unit 381 performs, based on the increased bandwidth, communication of packets with the communication device 110 via the first communication session.

In this case, regarding the first communication session, the bandwidth of the first communication session is increased by the congestion control until a packet loss is detected. However, the congestion management unit 383 further increases the bandwidth of the first communication session. From this, the data amount of transmittable packets is further increased in the new communication session. Accordingly, the relay device 380 becomes possible to immediately increase the throughput of the new communication session and is able to increase the communication throughput desired by the user.

### Second Embodiment

Next, a second embodiment will be described.

Example of Configuration of Communication System

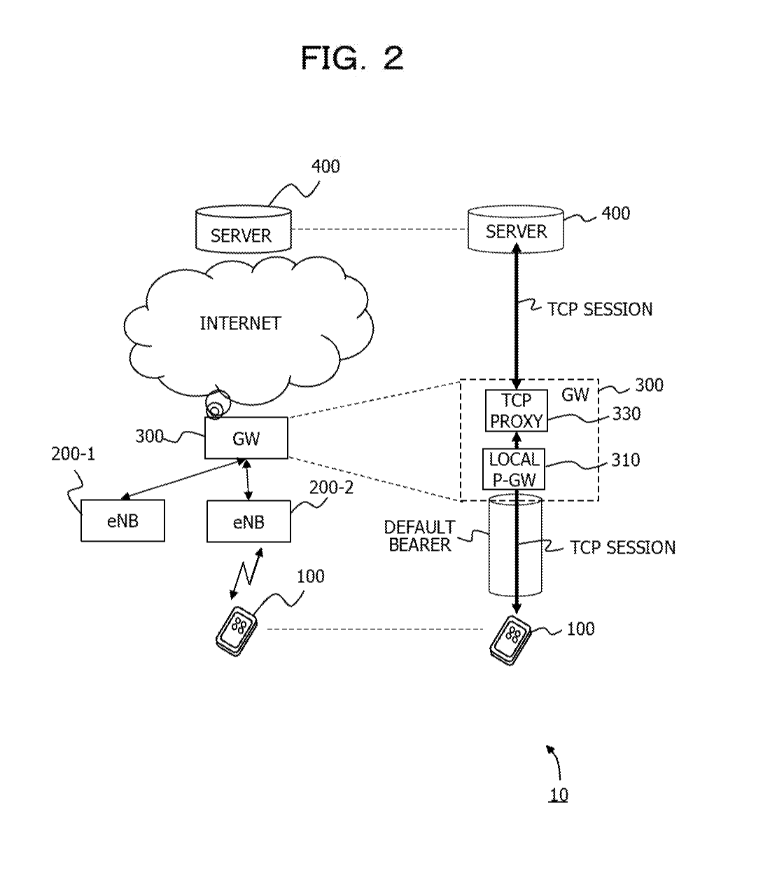

FIG. 2 is a diagram illustrating an example of a configuration of the communication system 10 in the present second embodiment. The communication system 10 includes a terminal device (or UE: hereinafter, called a “terminal” in some cases) 100 and base station devices (or eNBs: hereinafter, called “base stations” in some cases) 200-1 and 200-2. In addition, the communication system 10 includes a relay device (or a gateway device: hereinafter, called a “GW” in some cases) 300 and a server 400.

Note that the GW 300 corresponds to, for example, the relay device 380 in the first embodiment. In addition, the server 400 corresponds to, for example, the first or second server 410 or 420 in the first embodiment. Furthermore, the terminal 100 corresponds to, for example, the communication device 110 in the first embodiment.

The terminal 100 is a movable communication device such as, for example, a feature phone, a smartphone, a tablet terminal, a personal computer, or a game device. By performing wireless communication with the base stations 200-1 and 200-2, the terminal 100 is able to receive provision of various services such as a voice service and the Web browsing service.

Each of the base stations 200-1 and 200-2 is, for example, a communication device to perform wireless communication with the terminal 100 located within a communication-enabled range of the station itself. In addition, the base stations 200-1 and 200-2 each exchange data and so forth with the GW 300. The base stations 200-1 and 200-2 each fill the role of an interface to convert a wireless signal and data into each other. Note that while, in the communication system 10 illustrated in FIG. 2, the 2 base stations 200-1 and 200-2 are described, the communication system 10 may include 1 base station or may include 3 or more base stations.

The GW 300 is a relay device to relay data and so forth, exchanged between the server 400 and the terminal 100. In addition, the technologies of local breakout and mobile edge computing are used for the GW 300.

The term “local breakout (or offload)” means, for example, a technology for accessing the server 400 in the Internet via no mobile core network such as the EPC. While not illustrated in FIG. 2, the GW 300 may be connected to the EPC via the Internet and is able to transmit, to the EPC, packets and so forth, transmitted by the terminal 100, or to transmit the packets and so forth to the server 400 without transmitting the packets and so forth to the EPC. In order to utilize the technology of the local breakout, the GW 300 includes a local P-GW 310. The details of the local P-GW 310 will be described later.

In addition, the term “mobile edge computing” means a technology in which communication applications such as a content cache (hereinafter, called a “cache” in some cases) and a TCP proxy are deployed in the neighborhood of the terminal 100, such as, for example, the GW 300 or the base station 200-1 or 200-2. The GW 300 includes a TCP proxy 330 and a cache so as to be able to utilize the technology of the mobile edge computing. The details of the TCP proxy 330 and the cache will be described later.

Note that the term “communication session” or “session” means, for example, a period from the initiation of communication based on a transport layer protocol to the termination thereof. In addition, the term “TCP session” means, for example, a communication session utilizing a TCP protocol as the transport layer protocol. If the TCP session is set between devices, a TCP packet becomes transmittable between the devices. Even in a case of TCP sessions set between the same devices, if services vary according to the Web browsing service, the mail service, and so forth, a different TCP session may be set for each of the services. Accordingly, the term “TCP session” may mean, for example, a period from the initiation of communication of a TCP packet different depending on a service to the termination thereof. Each of the GW 300, the server 400, and the terminal 100 is able to perform communication of a packet via such a TCP session. The GW 300 is able to perform communication of a first packet with, for example, the terminal 100 via the first communication session and to perform communication of a second packet therewith via the second communication session. The first communication session may be, for example, a new TCP session, and the second communication session may be, for example, an existing TCP session.

The server 400 stores therein, for example, a content to be distributed to the terminal 100 and transmits the content to the GW 300 in accordance with a request from the GW 300.

Example of Configuration of GW

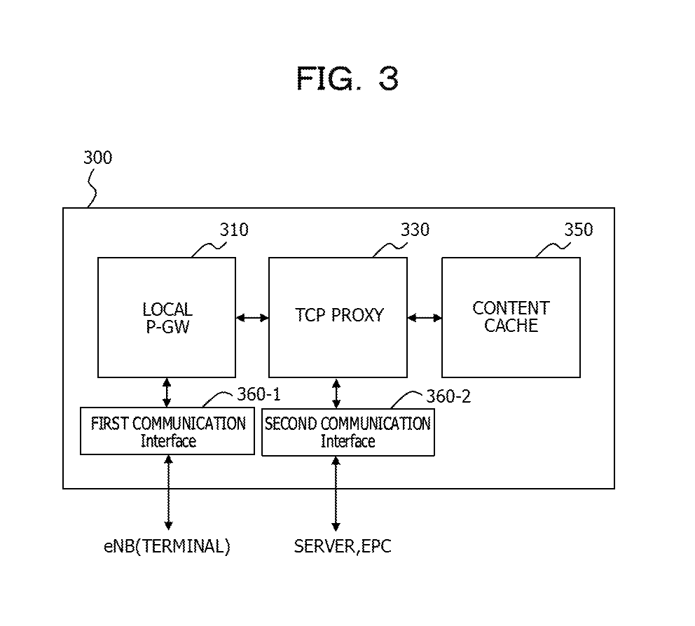

Next, an example of a configuration of the GW 300 will be described. FIG. 3 is a diagram illustrating an example of a configuration of the GW 300. The GW 300 includes the local P-GW 310, the TCP proxy 330, a cache 350, first and second communication interfaces 360-1 and 360-2.

The local P-GW 310 establishes a bearer with, for example, the terminal 100 via the base stations 200-1 and 200-2. The bearer may be a default bearer or a bearer other than the default bearer. As the bearer other than the default bearer, for example, the above-mentioned individual bearer may be cited. In what follows, the individual bearer will be described as an example of the bearer other than the default bearer. Communication based on voice is performed by, for example, the individual bearer, and communication other than the voice is performed by the default bearer.

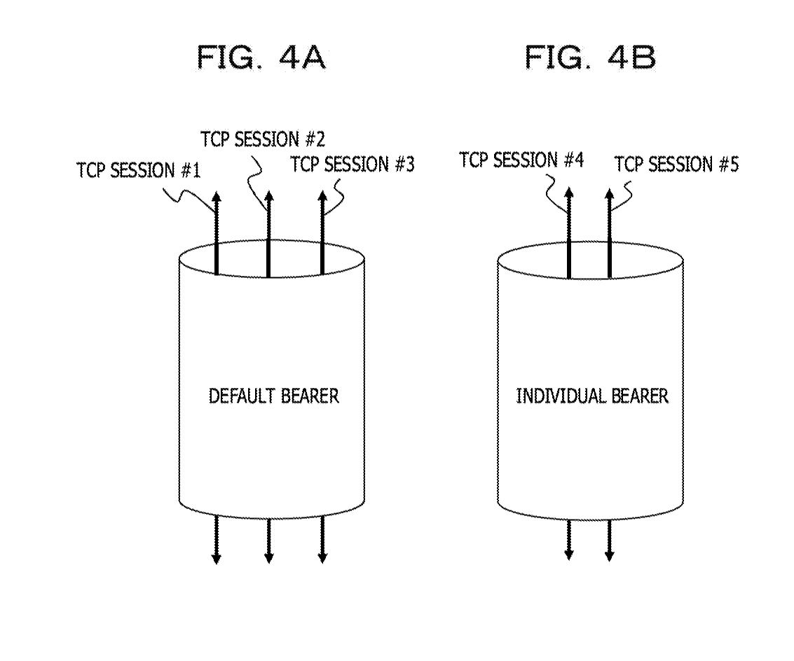

A bearer includes 1 or more TCP sessions in some cases. FIG. 4A illustrates an example of a relationship between the default bearer and TCP sessions, and FIG. 4B illustrates an example of a relationship between the individual bearer and TCP sessions. The default bearer includes 1 or more TCP sessions and includes 3 TCP sessions #1, #2, and #3 in the example of FIG. 4A. In addition, the individual bearer also includes 1 or more TCP sessions and includes 2 TCP sessions #4 and #5 in the example of FIG. 4B.

Returning to FIG. 3, the local P-GW 310 generates TFT (Traffic Flow Template) information and outputs the generated TFT information to the TCP proxy 330. The TCP proxy 330 becomes able to manage each of TCP sessions, based on the TFT information.

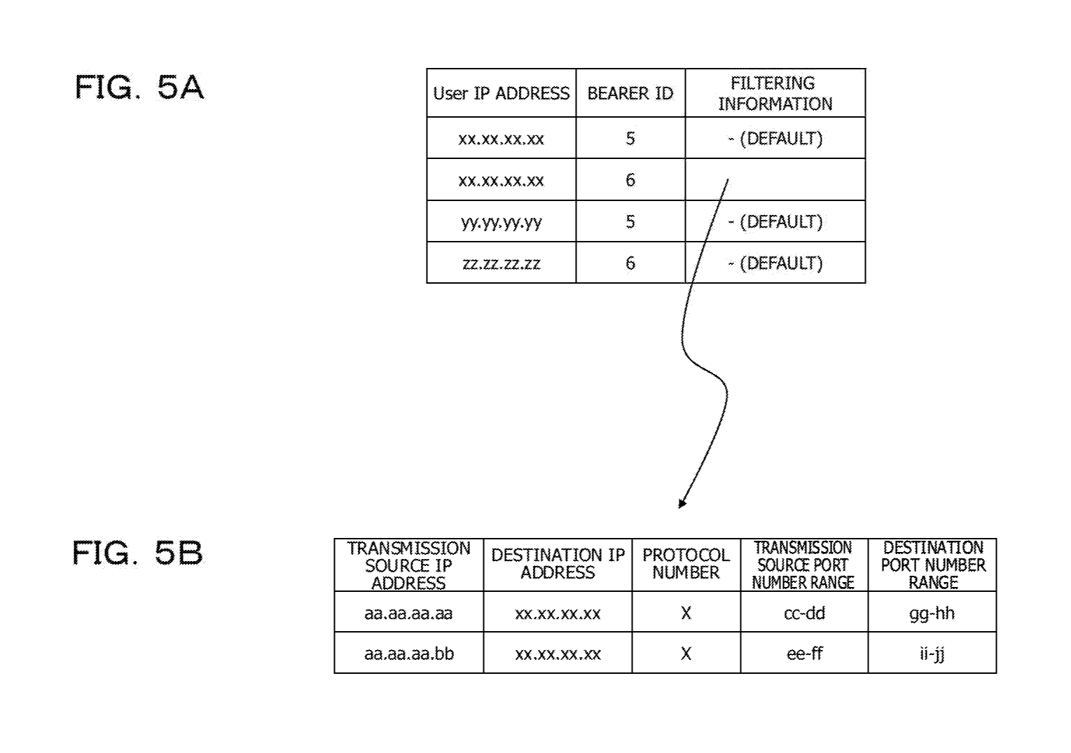

The term “TFT information” indicates a relationship between, for example, a bearer and a TCP session. FIG. 5A and FIG. 5B are diagrams each illustrating an example of the TFT information. The TFT information includes a “User IP address”, a “bearer ID”, and “filtering information”.

The “User IP address” indicates, for example, an IP address of the terminal 100 and may be an IP address issued by the local P-GW 310.

The “bearer ID” is, for example, identification information for identifying a bearer, and “5” and “6” indicate the bearer IDs of the default bearer and the individual bearer, respectively.

The “filtering information” indicates, for example, session information of the individual bearer. As illustrated in FIG. 5A, the default bearer includes no “filtering information”, and as illustrated in FIG. 5B, the individual bearer includes the “filtering information”.

The “filtering information” includes, for example, a “transmission source IP address”, a “destination IP address”, a “protocol number”, a “transmission source port number range”, and a “destination port number range”.

The “transmission source IP address” indicates, for example, an IP address of the terminal 100 or server 400 to serve as a transmission source of a packet, and the “transmission source port number range” indicates, for example, the range of a port number of the terminal 100 or server 400 to serve as the transmission source.

The “destination IP address” indicates, for example, an IP address of the terminal 100 or server 400 to serve as a destination of a packet, and the “destination port number range” indicates, for example, the range of a port number of the terminal 100 or server 400 to serve as the destination.

The “protocol number” is, for example, identification information for identifying a protocol in a transport layer, such as a TCP or a user datagram protocol (UDP).

FIG. 5A and FIG. 5B illustrate an example in which 2 bearers of the default bearer and the individual bearer are set for the terminal 100 whose IP address is “xx.xx.xx.xx”. In addition, an example in which the individual bearer of the terminal 100 is set for accesses to two servers where one server's IP address is “aa.aa.aa.aa” and the other server's IP address is “aa.aa.aa.ab” is illustrated. The terminal 100 newly accesses, for example, the server (“aa.aa.aa.aa”), thereby generating a new TCP session for an existing TCP session with respect to the previously accessed server (“aa.aa.aa.ab”). In this way, if, for example, the “transmission source IP address” or the “destination IP address” is different, a TCP session varies. It may be said that the filtering information in the upper row and the filtering information in the lower row, illustrated in FIG. 5B, indicate respective different TCP sessions. Accordingly, the local P-GW 310 is able to generate the filtering information for each of TCP sessions.

Default bearer information includes a “User IP address”. In addition, individual bearer information includes session information to be contained in the individual bearer. As the session information, there are, for example, the “transmission source IP address”, the “destination IP address”, the “protocol number”, the “transmission source port number range”, and the “destination port number range”.

The local P-GW 310 generates, for example, such TFT information. For example, the following processing is performed.

In other words, the local P-GW 310 receives a connection request transmitted by the terminal 100 and issues an IP address (the “User IP address”) to the terminal 100, based on the identification information of the terminal 100, included in the connection request. In addition, based on a communication type, destination information, and so forth, included in the connection request, the local P-GW 310 generates the bearer ID and the filtering information.

Alternatively, upon receiving an instruction from a mobility management entity (MME) connected to a mobile network of the EPC, the local P-GW 310 may generate the TFT information. The relevant instruction may include, for example, information, included in the connection request transmitted by the terminal 100, and so forth.

The local P-GW 310 may output, to the TCP proxy 330, all pieces of information included in the TFT information or may output, to the TCP proxy 330, some pieces of information included in the TFT information.

Returning to FIG. 3, the TCP proxy 330 manages a TCP session between the server 400 and the TCP proxy 330 and a TCP session between the TCP proxy 330 and the terminal 100. In this case, the TCP proxy 330 may manage the TCP session between the TCP proxy 330 and the terminal 100, based on the TFT information. The details of the TCP proxy 330 will be described later.

The cache 350 stores a content received from the server 400. In addition, upon receiving an acquisition request for a content, transmitted by the terminal 100, the cache 350 transmits to the terminal 100 on behalf of the server 400.

The first communication interface 360-1 converts data and so forth, output by the local P-GW 310, into packet data (hereinafter, called “packets” in some cases) such as a TCP packet and transmits the packet data to the terminal 100 via the base stations 200-1 and 200-2. In addition, the first communication interface 360-1 receives packets transmitted by the terminal 100 via the base stations 200-1 and 200-2 and extracts and outputs data and so forth from the received packets and to the local P-GW 310.

The second communication interface 360-2 converts data and so forth, output by the TCP proxy 330, into packets and transmits the converted packets to the server 400 or the EPC. In addition, the second communication interface 360-2 receives packets transmitted by the server 400 or the EPC and 200-2 and extracts and outputs data and so forth from the received packets and to the TCP proxy 330.

Data, related to a content and transmitted by the server 400, is stored in the cache 350 via the second communication interface 360-2 and the TCP proxy 330. In addition, data, related to a content and read from the cache 350, is transmitted to the terminal 100 via the TCP proxy 330, the local P-GW 310, and the first communication interface 360-1.

Example of Configuration of TCP Proxy

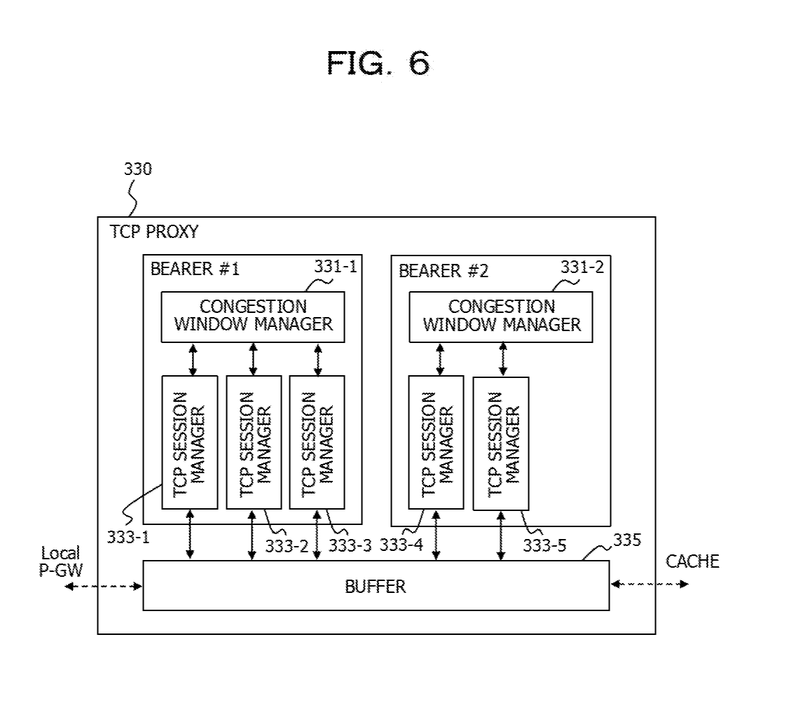

Next, an example of a configuration of the TCP proxy 330 will be described. FIG. 6 is a diagram illustrating an example of the configuration of the TCP proxy 330.

For each of bearers set in the local P-GW 310, the TCP proxy 330 manages each of TCP sessions contained in the relevant bearer. The TCP proxy 330 includes congestion window managers (or congestion management units) 331-1 and 331-2 and TCP session managers 333-1 to 333-5.

Note that the congestion window managers 331-1 and 331-2 correspond to, for example, the congestion management unit 383 in the first embodiment. In addition, the TCP session manager 333-1 corresponds to, for example, the first communication session management unit 381 in the first embodiment. Furthermore, the TCP session manager 333-2 corresponds to, for example, the second communication session management unit 382 in the first embodiment.

In the example of FIG. 6, the TCP proxy 330 provides the congestion window manager 331-1 and the 3 TCP session managers 333-1 to 333-3 to a bearer #1 (for example, the default bearer). In addition, the TCP proxy 330 provides the congestion window manager 331-2 and the 2 TCP session managers 333-4 and 333-5 to a bearer #2 (for example, the individual bearer).

Upon receiving a predetermined notice from one of the TCP session managers 333-1 to 333-3, the congestion window manager 331-1 updates a congestion window of a TCP session to serve as a target. In addition, the congestion window manager 331-1 outputs the updated congestion window to the corresponding one of the TCP session managers 333-1 to 333-3, which manages the relevant TCP session, and instructs to update a congestion window. The same applies to the congestion window manager 331-2. In what follows, unless otherwise noted, regarding the congestion window managers 331-1 and 331-2, the congestion window manager 331-1 will be described. Details of processing performed in the congestion window manager 331-1 will be described in examples of operations.

Each of the TCP session managers 333-1 to 333-5 manages each TCP session and performs communication of packets with the terminal 100 via the TCP session managed by the relevant TCP session manager. In addition, after transmission of packets, each of the TCP session managers 333-1 to 333-5 receives a reception acknowledgement response (ACK) from the terminal 100 or detects a packet loss of a transmitted packet. Upon receiving a reception acknowledgement response or detecting a packet loss, the corresponding one of the TCP session managers 333-1 to 333-5 outputs, to the congestion window manager 331-1 or 331-2, the relevant predetermined notice indicating that effect.

In addition, the corresponding one of the TCP session managers 333-1 to 333-5 receives the updated congestion window from the congestion window manager 331-1 or 331-2 and performs congestion control by using the updated congestion window. The corresponding one of the TCP session managers 333-1 to 333-5 arbitrarily reads and outputs a packet, stored in the buffer 335, to the local P-GW 310 and transmits the packet to the terminal 100.

The buffer 335 stores therein, based on control performed by each of the TCP session managers 333-1 to 333-5, a packet received from the server 400 by the TCP proxy 330 or stores therein a packet received from the terminal 100 via the local P-GW 310.

In addition to a predetermined notice output by the corresponding one of the TCP session managers 333-1 to 333-3, the congestion window manager 331-1 receives various parameters. The congestion window manager 331-1 holds the received parameters in an internal memory or the like and manages the parameters.

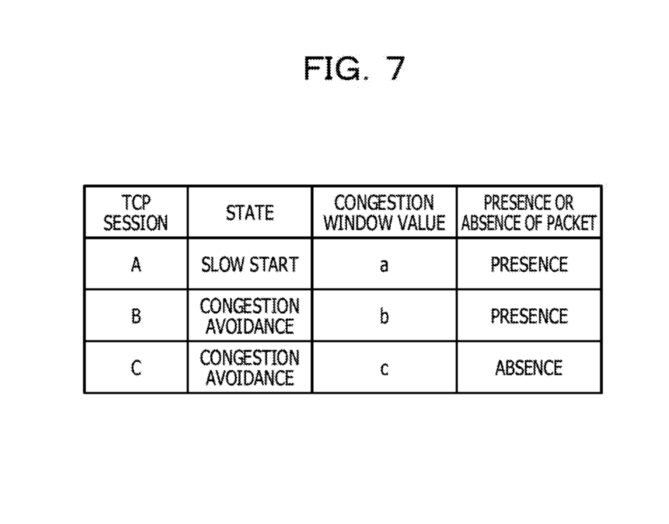

FIG. 7 illustrates examples of parameters managed by the congestion window managers 331-1 and 331-2. The parameters include a “state”, a “congestion window value”, and “presence or absence of a packet”, related to each of TCP sessions.

The “state” indicates, for example, a state in congestion control of a TCP session. As a state in the congestion control, there are 2 states of “slow start” and “congestion avoidance”.

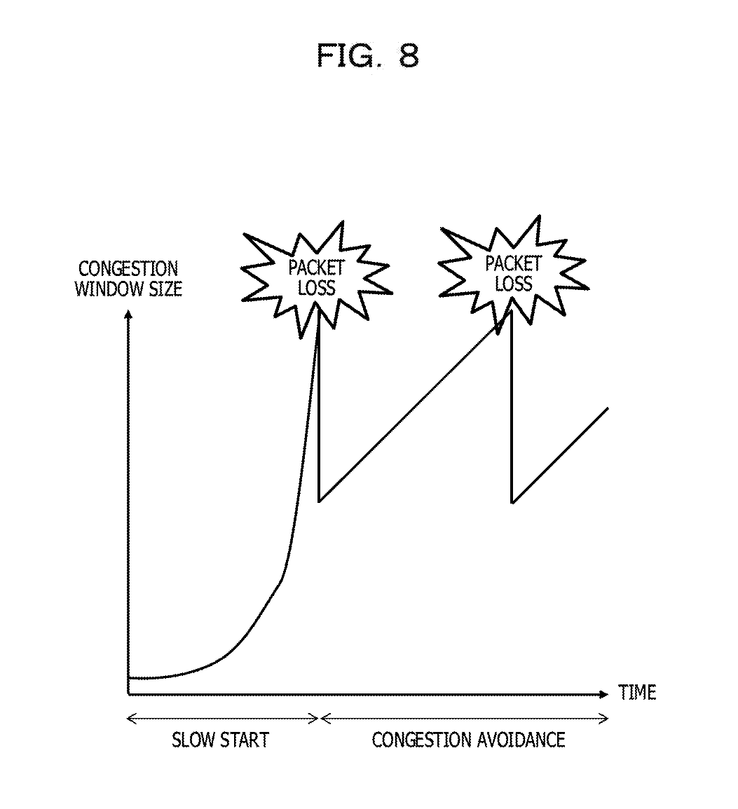

Here, an example of the congestion control will be described. FIG. 8 is a diagram illustrating an example of the congestion control. In FIG. 8, a horizontal axis indicates a time, and a vertical axis indicates a congestion window.

In the congestion control, in a case where a new TCP session is generated, control for the “slow start” is performed on a transmitting side first. The “slow start” is control for exponentially increasing the congestion window from, for example, a minimum congestion window (for example, “0”, “1”, or the like). The term “congestion window” means, for example, the amount of transmittable data. In the “slow start”, the transmitting side starts from a minimum data amount and exponentially increases a data amount, thereby transmitting packets.

In addition, if the congestion window is increased and a packet loss occurs, the transmitting side determines that the state is congestion, and the transmitting side makes a transition from the “slow start” to the “congestion avoidance”. The “congestion avoidance” is, for example, control for linearly increasing the congestion window. Upon making a transition to the “congestion avoidance”, the transmitting side decreases the congestion window to a threshold value and linearly increases the congestion window, and if a packet loss occurs again, the transmitting side decreases the congestion window to the threshold value.

Such congestion control is performed for, for example, each of TCP sessions. In a case where the TCP session manager 333-1 performs, for, for example, a first TCP session, the congestion control based on the “slow start”, the TCP session manager 333-2 performs, for a second TCP session, the congestion control based on the “congestion avoidance”. If each of the TCP session managers 333-1 to 333-3 initiates the “slow start” for a TCP session managed by the relevant TCP session manager itself or makes a transition to the “congestion avoidance”, the relevant TCP session manager informs the congestion window manager 331-1 to that effect.

Note that, in the present second embodiment, a TCP session in which the congestion control is performed until an initial packet loss occurs after initiation of the TCP session is called, for example, a new TCP session in some cases. In addition, a TCP session in which the congestion control is performed after an initial packet loss occurs is called, for example, an existing TCP session in some cases.

The TCP session manager (for example, the first communication session management unit) 333-1 manages, for example, the new TCP session and performs the congestion control based on the “slow start”, as a first state. In addition, the TCP session manager (for example, the second communication session management unit) 333-2 manages, for example, the existing TCP session and performs the congestion control based on the “congestion avoidance”, as a second state.

Returning to FIG. 7, the “congestion window value” indicates, for example, a value of the congestion window of the relevant TCP session. Each of the TCP session managers 333-1 to 333-3 may increase the congestion window value every time, for example, ACK is received, and the relevant TCP session manager may notify the congestion window manager 331-1 of the increased congestion window value. Note that, in the present specification, it is assumed that the congestion window and the congestion window value are used without particular distinction.

The “presence or absence of a packet” indicates, for example, whether or not a packet to be transmitted to the terminal 100 in a TCP session remains in the buffer 335. Each of the TCP session managers 333-1 to 333-3 confirms, for example, whether or not a packet to be transmitted via a TCP session managed by the relevant TCP session manager itself is stored in the buffer 335, and the relevant TCP session manager may notify the congestion window manager 331-1 of a confirmation result thereof.

Examples of Operations

Next, examples of operations performed by the GW 300 will be described. As examples of operations, there is an example of an operation in a case where ACK is received in an existing TCP session. In addition, there is an example of an operation in a case where a packet loss is detected in a new TCP session. In what follows, the 2 examples of operations will be described.

Example of Operation in Case where ACK is Received

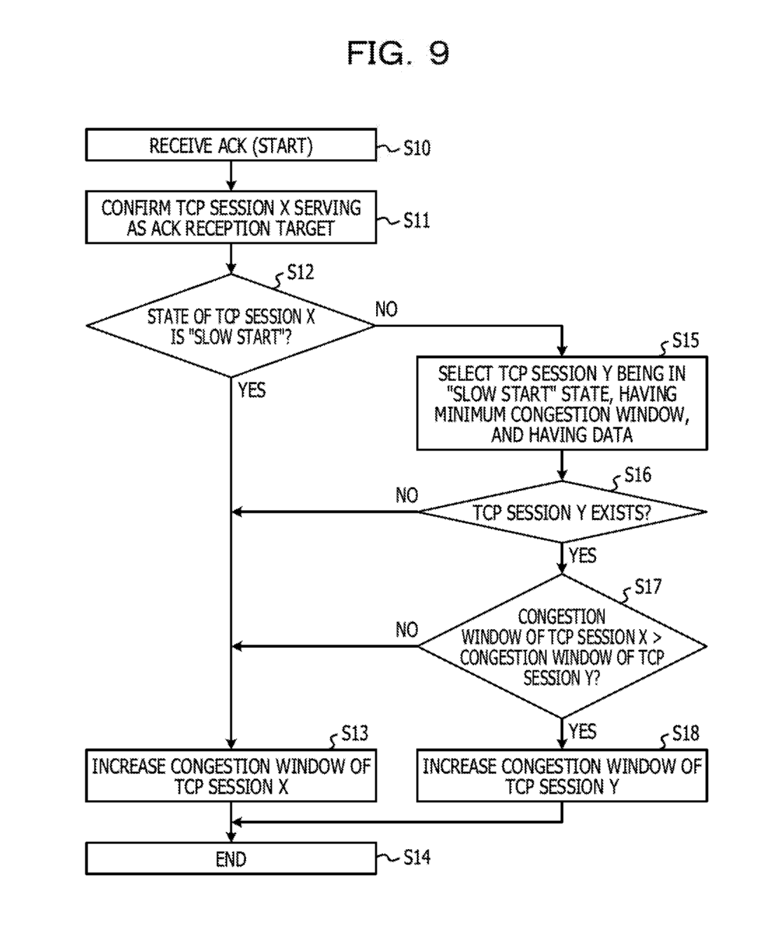

FIG. 9 is a flowchart illustrating an example of an operation in a case where ACK is received in an existing or new TCP session after the new TCP session is generated by the TCP proxy 330. The example of an operation illustrated in FIG. 9 is mainly performed by each of the congestion window managers 331-1 and 331-2 in the TCP proxy 330. In what follows, unless otherwise noted, the congestion window manager 331-1 will be described as an example.

Upon receiving ACK in an existing or new TCP session, the TCP proxy 330 starts processing (S10). In a case where the TCP session manager 333-1 manages, for example, a new TCP session and the TCP session manager 333-2 manages, for example, an existing TCP session, the TCP session manager 333-2 informs the congestion window manager 331-1 to the effect of receiving the ACK. Upon receiving this notice, the congestion window manager 331-1 may start processing.

Next, the TCP proxy 330 confirms a TCP session X serving as an ACK reception target (S11). Based on, for example, a connection relationship with the TCP session managers 333-1 to 333-3, the congestion window manager 331-1 understands which of TCP sessions is the TCP session X serving as a target. Upon receiving a notice of ACK from, for example, the TCP session manager 333-1, the congestion window manager 331-1 confirms that the TCP session X serving as a target is a TCP session #A. In addition, upon receiving a notice of ACK from, for example, the TCP session manager 333-2, the congestion window manager 331-1 confirms that the TCP session X serving as a target is a TCP session #B.

Next, the TCP proxy 330 judges whether or not the state of the TCP session X serving as a target is the “slow start” (S12). Based on, for example, the TCP session X confirmed in S11 and the “state” serving as a parameter (in, for example, FIG. 7) that corresponds to the relevant TCP session X and that is stored in the internal memory or the like, the congestion window manager 331-1 judges. In a case where the TCP session X confirmed in S11 is in, for example, the “slow start”, the congestion window manager 331-1 judges as being the “slow start” (Yes). In addition, in a case where the TCP session X confirmed in S11 is in, for example, the “congestion avoidance”, the congestion window manager 331-1 judges as not being the “slow start” (No).

In a case where the state of the TCP session X is the “slow start” (S12: Yes), the TCP proxy 330 increases the congestion window of the TCP session X (S13). In this case, the congestion window manager 331-1 does not particularly instruct one of the TCP session managers 333-1 to 333-3, which manages the TCP session X serving as a target. The relevant one of the TCP session managers 333-1 to 333-3 performs, on the new TCP session X, control based on the normal slow start, thereby exponentially increasing the corresponding congestion window.

In addition, the TCP proxy 330 terminates a series of processing operations (S14).

On the other hand, in a case where the state of the TCP session X is not the “slow start” (S12: No), the TCP proxy 330 selects a TCP session Y that is in a “slow start” state, that has a minimum congestion window, and that has data (S15). In the present processing operation, the TCP session X serving as a target is an existing TCP session, a transmittable packet is stored in the buffer 335, and the new TCP session Y having a minimum congestion window is selected. In a case where there are new TCP session Ys, one of the new TCP sessions, which has a minimum congestion window, is selected, and in a case where there is only 1 new TCP session, the relevant new TCP session is selected. Based on, for example, parameters (in, for example, FIG. 7) held in the internal memory or the like, the congestion window manager 331-1 selects the corresponding TCP session Y. In the example of FIG. 7, in a case where the TCP session X serving as a target is a TCP session “B”, the congestion window manager 331-1 selects, as the corresponding TCP session Y, a TCP session “A” that is in the “slow start” state, that has a minimum congestion window, and that has a packet.

Next, the TCP proxy 330 determines whether or not the TCP session Y selectable in S15 exists (S16), and in a case where the corresponding TCP session Y does not exist (S16: No), the TCP proxy 330 increases the congestion window of the TCP session X (S13). In this case, the new TCP session Y does not exist, and only the existing TCP session X exists. Therefore, regarding the existing TCP session X, the TCP proxy 330 linearly increases the corresponding congestion window, based on control for the normal “congestion avoidance”. In this case, the congestion window manager 331-1 does not particularly instruct, for example, the corresponding one of the TCP session managers 333-1 to 333-3, which manages the TCP session X. In this case, the corresponding one of the TCP session managers 333-1 to 333-2, which manages the TCP session X, increases the corresponding congestion window, in accordance with control for the normal “congestion avoidance”.

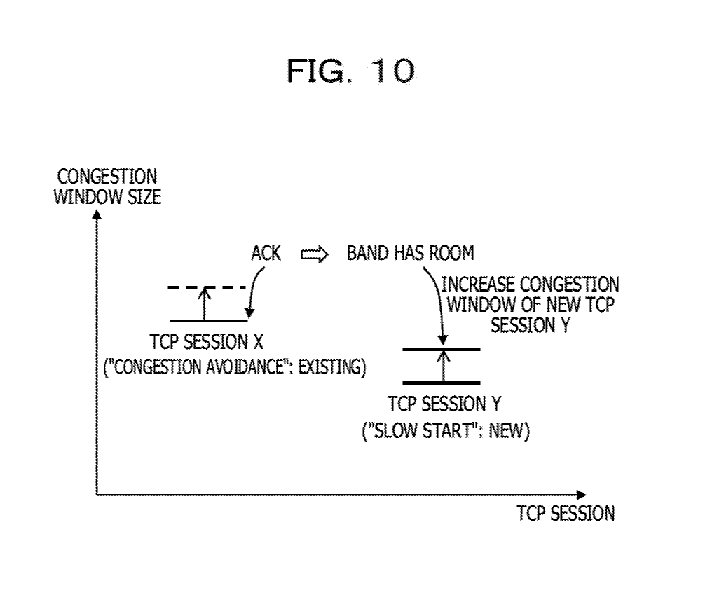

On the other hand, in a case where the new TCP session Y selectable in S15 exists (S16: Yes), the TCP proxy 330 determines whether or not the TCP session X serving as a target has a larger congestion window than that of the new TCP session Y selected in S15 (S17). The present processing operation will be described by using FIG. 10.

FIG. 10 is a diagram illustrating examples of congestion window sizes of the respective 2 TCP sessions X and Y. In FIG. 10, a vertical axis indicates a congestion window, and a horizontal axis indicates the individual TCP sessions. The TCP session X serving as a target is an existing TCP session, and the TCP session Y is a new TCP session having a minimum congestion window.

As illustrated in FIG. 10, a case where ACK is transmitted to the existing TCP session X (S11) when the congestion window of the existing TCP session X is larger than the congestion window of the new TCP session Y (S17: Yes) will be considered. In this case, the ACK is transmitted to the existing TCP session X. Therefore, a data amount (hereinafter, called a “band”, an “entire bandwidth”, or the like in some cases) transmittable in an entire bearer to contain the existing TCP session X has room. In a case where, in the entire bearer, the band has room, the congestion window of the existing TCP session is not increased by an amount of a predetermined size in accordance with the “congestion avoidance” control but the congestion window of the new TCP session is increased. While, in the new TCP session, the corresponding congestion window is increased based on control for the “slow start”, the corresponding congestion window turns out to be further increased by an increased amount.

The increased amount of the new TCP session may be an increased amount of the congestion window of the existing TCP session.

From this, the congestion window of the new TCP session Y turns out to be increased faster than the increased amount of the congestion window based on the “slow start”.

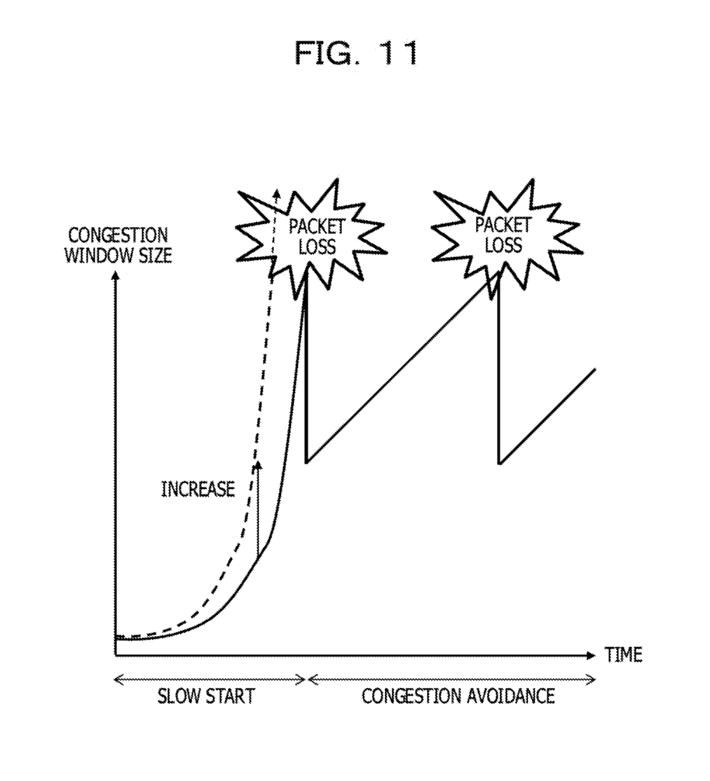

FIG. 11 illustrates a state in which the congestion window of the new TCP session Y is increased at a speed faster than a congestion window, based on the normal “slow start” and indicated by a solid line. A congestion window size is increased at a speed faster than in the normal “slow start”, and accordingly, the increased amount of a transmittable data amount becomes faster than in the normal “slow start”. Accordingly, it becomes possible to immediately increase the throughput of the new TCP session Y. In addition, since the throughput of the new TCP session Y is immediately increased, it is possible to increase the throughput of communication desired by a user.

Returning to FIG. 9, as described above, in a case where the congestion window of the existing TCP session X is larger than that of the new TCP session Y (S17: Yes), the TCP proxy 330 increases the congestion window of the new TCP session Y (S18). For example, the following processing is performed.

In other words, the congestion window manager 331-1 reads, from the parameters (in, for example, FIG. 7) held in the internal memory, the corresponding 2 congestion windows of the respective TCP sessions and judges. In addition, in a case where the congestion window of the existing TCP session X is larger than that of the new TCP session Y, the congestion window manager 331-1 increases the congestion window of the new TCP session Y, held in the internal memory, by a predetermined amount and updates it. The congestion window manager 331-1 notifies the corresponding one of the TCP session managers 333-1 to 333-3, which manages the new TCP session Y, of the updated congestion window. Upon receiving the relevant notice, the corresponding one of the TCP session managers 333-1 to 333-3, which manages the new TCP session Y, sets the corresponding congestion window to the updated congestion window. In this case, the congestion window of the new TCP session Y becomes a value larger than that of a congestion window in the normal “slow start”. Therefore, it becomes possible to increase the corresponding congestion window at a timing earlier than that of the control for the normal “slow start”.

In addition, the TCP proxy 330 terminates the series of processing operations (S14). After that, for example, the TCP session manager 333-2 that manages the new TCP session Y performs communication of a packet with the terminal 100 via the new TCP session Y, based on the congestion window for which an instruction is received from the congestion window manager 331-1.

On the other hand, in a case where the congestion window of the existing TCP session X is not larger than that of the new TCP session Y (S17: No), the TCP proxy 330 increases the congestion window of the existing TCP session X (S13). In this case, the congestion window of the new TCP session Y is larger than that of the existing TCP session X. Therefore, the congestion window of the existing TCP session X having a smaller congestion window is increased. In this case, the congestion window manager 331-1 does not update the corresponding congestion window, and the corresponding one of the TCP session managers 333-1 to 333-2, which manages the existing TCP session X, linearly increases the corresponding congestion window in accordance with the control for the normal “congestion avoidance”.

In addition, the TCP proxy 330 terminates the series of processing operations (S14).

Case where Packet Loss is Detected

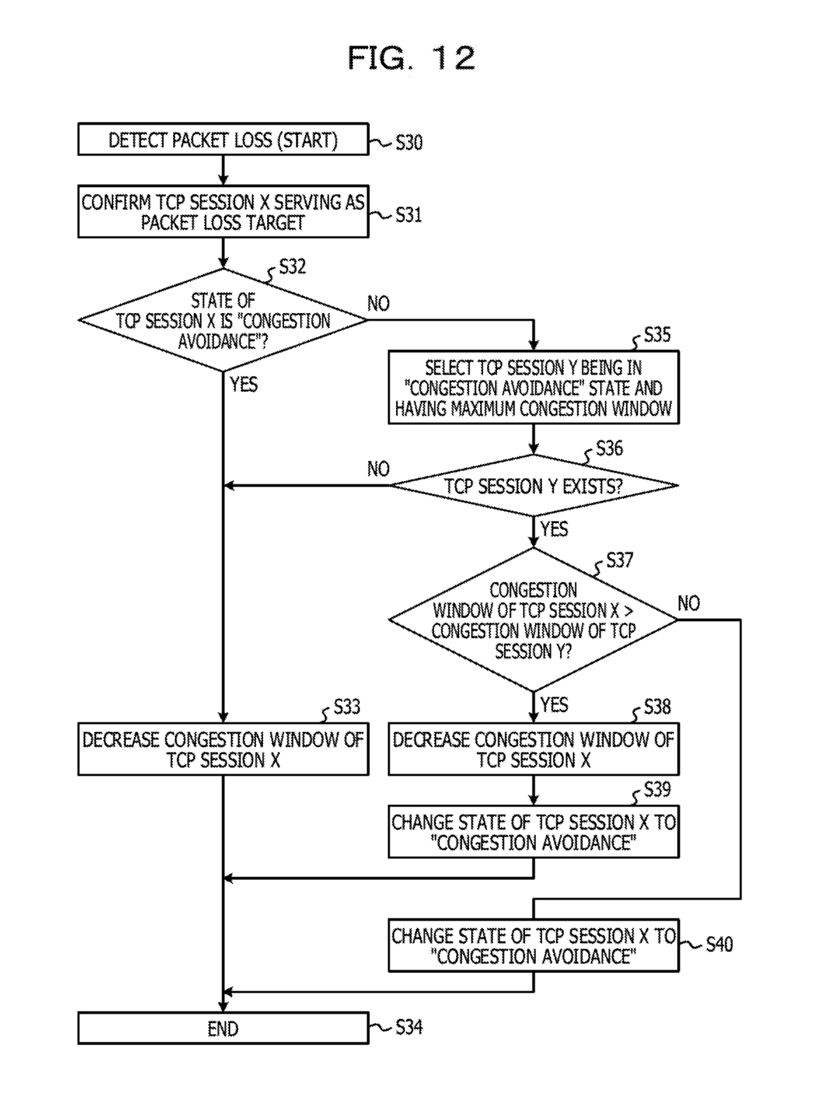

Next, an example of an operation in a case where a packet loss is detected in an existing or new TCP session will be described. FIG. 12 is a flowchart illustrating an example of an operation. The example of an operation illustrated in FIG. 12 is mainly performed by the congestion window manager 331-1 in the TCP proxy 330.

Upon detecting a packet loss in an existing or new TCP session, the TCP proxy 330 starts processing (S30). The detection of a packet loss may be performed based on, for example, a known method. In, for example, a case where no reception acknowledgement response is received even after the elapse of a predetermined time period subsequent to transmission of a packet or in a case where the same reception acknowledgement responses in which the number thereof is greater than or equal to a predetermined number are received within a predetermined time period, one of the TCP session managers 333-1 to 333-3 may detect an occurrence of a packet loss. Alternatively, in a case where a reception negative response (negative acknowledge (NACK)) is received within a predetermined time period, the corresponding one of the TCP session managers 333-1 to 333-3 may detect that a packet loss occurs.

Next, the TCP proxy 330 detects whether or not the state of the TCP session X serving as a target is the “congestion avoidance” (S32). In the same way as in S12, the congestion window manager 331-1 may judge based on parameters stored in the internal memory.

In a case where the state of the TCP session X serving as a target is the “congestion avoidance” (S32: Yes), the TCP proxy 330 decreases the congestion window of the TCP session X (S33). In this case, the TCP session X serving as a target is an existing TCP session because of being in a “congestion avoidance” state, and a packet loss is detected in the existing TCP session X (S30). Therefore, the corresponding congestion window is decreased to a threshold value. For example, the congestion window manager 331-1 does not particularly instruct the corresponding one of the TCP session managers 333-1 to 333-3, which manages the existing TCP session X. In this case, the corresponding one of the TCP session managers 333-1 to 333-3, which manages the existing TCP session X, decreases the corresponding congestion window to the threshold value, based on the “congestion avoidance”.

In addition, the TCP proxy 330 terminates a series of processing operations (S34).

On the other hand, in a case where the state of the TCP session X is not the “congestion avoidance” (S32: No), the TCP proxy 330 selects the TCP session Y, which is in the “congestion avoidance” state and which has a maximum congestion window (S35). In this case, the TCP session X serving as a target is a new TCP session because of being in the “slow start” state. In addition, the TCP session Y, which is in the “congestion avoidance” state, in other words, which has a maximum congestion window among existing TCP sessions, is selected. In a case where there are existing TCP session Ys, one of the existing TCP sessions Y, which has a maximum congestion window, is selected, and in a case where there is only 1 existing TCP session, the relevant existing TCP session is selected. Based on, for example, held parameters, the congestion window manager 331-1 selects the corresponding TCP session Y, which is a TCP session different from the TCP session X, which is in the “congestion avoidance” state, which holds a transmitted packet, and which has a maximum congestion window. In the example of FIG. 7, in a case where the TCP session X serving as a target is the TCP session “A”, the congestion window manager 331-1 selects, as the corresponding TCP session Y, the TCP session “B”.

Returning to FIG. 12, next, the TCP proxy 330 determines whether or not the TCP session Y selectable in S35 exists (S36), and in a case where the corresponding TCP session Y does not exist (S36: No), the TCP proxy 330 decreases the congestion window of the TCP session X (S33). In this case, for the new TCP session X (S32: No), the packet loss is detected (S30). Therefore, the congestion window manager 331-1 decreases the congestion window of the new TCP session X. The present processing operation corresponds to a case where since an initial packet loss occurs for a TCP session put into the “slow start” state in, for example, FIG. 8, the corresponding congestion window is decreased to the threshold value. For example, the congestion window manager 331-1 does not particularly instruct the corresponding one of the TCP session managers 333-1 to 333-3, which manages the new TCP session X. In this case, the corresponding one of the TCP session managers 333-1 to 333-2, which manages the new TCP session X, decreases the corresponding congestion window, in accordance with control for the normal “slow start”.

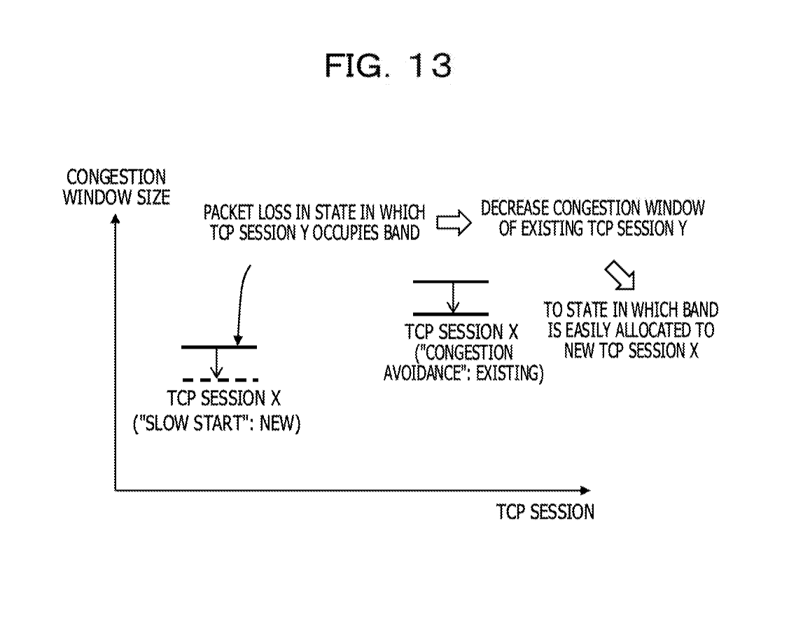

On the other hand, in a case where the TCP session Y selectable in S35 exists (S36: Yes), the TCP proxy 330 determines whether or not the TCP session X serving as a target has a larger congestion window than that of the TCP session Y selected in S35 (S37). The present processing operation (S37) will be described by using FIG. 13.

FIG. 13 is a diagram illustrating examples of congestion window sizes of the respective 2 TCP sessions X and Y. In FIG. 13, a vertical axis indicates a congestion window, and a horizontal axis indicates the individual TCP sessions. Since being in the “slow start” state (S32: No), the TCP session X serving as a target is a new TCP session. In addition, the TCP session Y put into the “congestion avoidance” state is an existing TCP session. A case where a packet loss is detected for the new TCP session X when the congestion window of the new TCP session X is smaller than the congestion window of the existing TCP session Y will be considered. In this case, the normal “slow start” control decreases the congestion window of the new TCP session. However, in a case where the congestion window of the existing TCP session Y is larger than the congestion window of the new TCP session X, there occurs a state in which the existing TCP session Y occupies a bandwidth larger than that of the new TCP session X within the entire bandwidth of a bearer.

Therefore, in the present second embodiment, in a case where a packet loss of the new TCP session X is detected in a state in which the congestion window of the existing TCP session Y occupies the bandwidth of the bearer, the congestion window of the existing TCP session Y is decreased. The congestion window of the existing TCP session Y is decreased while the congestion window of the new TCP session X is not decreased. Therefore, the congestion window of the new TCP session X is put into a state of being able to be increased (or an allocatable state). After that, if ACK is sent back for, for example, the new TCP session X, the corresponding one of the TCP session managers 333-1 to 333-3, which manages the new TCP session X, increases the congestion window of the new TCP session X. Accordingly, the new TCP session X turns out not to decrease a transmission data amount and is able to increase the transmission data amount. Therefore, it is possible to immediately increase the throughput of the new TCP session. FIG. 11 illustrates an example of a temporal change of a congestion window. As indicated by a dotted line in FIG. 11, even if an initial packet loss occurs, the congestion window of the new TCP session X in the “slow start” state is increased.

Therefore, in the present second embodiment, it becomes possible to immediately increase the throughput of the new TCP session X. In addition, since the throughput of the new TCP session X is immediately increased, it is possible to increase the throughput of communication desired by a user.

Returning to FIG. 12, in a case where the congestion window of the new TCP session X is not larger (or is smaller) than that of the existing TCP session Y (S37: No), the TCP proxy 330 decreases the congestion window of the existing TCP session Y, as described above. For example, the following processing is performed.

In other words, based on parameters held in the internal memory, the congestion window manager 331-1 judges that the new TCP session X is smaller than the existing TCP session Y. In addition, the congestion window manager 331-1 decreases the congestion window of the existing TCP session Y and stores the decreased congestion window in the internal memory. The congestion window manager 331-1 instructs the corresponding one of the TCP session managers 333-1 to 333-3, which manages the existing TCP session Y, to decrease the corresponding congestion window. In accordance with the instruction, the corresponding one of the TCP session managers 333-1 to 333-2, which manages the existing TCP session Y, decreases the congestion window of the existing TCP session Y to the threshold value. In this way, based on the corresponding congestion window for which the instruction is received, the corresponding one of the TCP session managers 333-1 to 333-2, which manages the existing TCP session Y, performs communication of a packet with the terminal 100 via the existing TCP session.

On the other hand, in a case where the congestion window of the new TCP session X is larger than that of the existing TCP session Y (S37: Yes), the TCP proxy 330 decreases the congestion window of the new TCP session X (S38). In this case, the congestion window of the new TCP session X is larger than that of the existing TCP session Y. Therefore, the congestion window of the new TCP session X having a larger congestion window is decreased. In this case, for example, the congestion window manager 331-1 does not particularly instruct the corresponding one of the TCP session managers 333-1 to 333-3, which manages the new TCP session X. The corresponding one of the TCP session managers 333-1 to 333-3, which manages the new TCP session X, decreases the corresponding congestion window in accordance with normal processing at a time of occurrence of a packet loss.

Next, the TCP proxy 330 changes, to the “congestion avoidance”, the state of the new TCP session X whose congestion window is decreased (S39). Among parameters (in, for example, FIG. 7) held in the internal memory, the congestion window manager 331-1 changes, from the “slow start” to the “congestion avoidance”, the state of, for example, the new TCP session X and stores it.

In addition, the TCP proxy 330 terminates the series of processing operations (S34).

### Other Embodiments

In the above-mentioned second embodiment, examples of 2 control operations of the “slow start” (for example, the first state) and the “congestion avoidance” (for example, the second state) are described as the congestion control. After detection of, for example, an initial packet loss, the congestion control is performed based on the “slow start”, in some cases. In other words, after detection of an initial packet loss, the corresponding congestion window is set to an initial value, thereby performing the “slow start”, and if a threshold value is reached after that, the “congestion avoidance” is applied, and the “congestion avoidance” is applied until a packet loss is further detected. In this case, a TCP session may be defined as a new TCP session until, for example, an initial packet loss is detected, a TCP session in which the “slow start” and the “congestion avoidance” after detection of an initial packet loss are performed may be defined as an existing TCP session, and the above-mentioned processing may be performed.

In addition, as an algorithm for the congestion avoidance before detection of an initial packet loss, the “slow start” is usual. However, the congestion control may be performed based on the “congestion avoidance” or a combination of the “congestion avoidance” and the “slow start”. In addition, as an algorithm for the congestion avoidance after detection of an initial packet loss, an algorithm other than the “congestion avoidance” may be adopted, as described above. Even if any algorithms are performed as the congestion control before and after an occurrence of an initial packet loss, a TCP session may be defined as a “new TCP session” before the occurrence of an initial packet loss, the TCP session may be defined as an “existing TCP session” after that, and the processing described in the above-mentioned second embodiment may be performed.

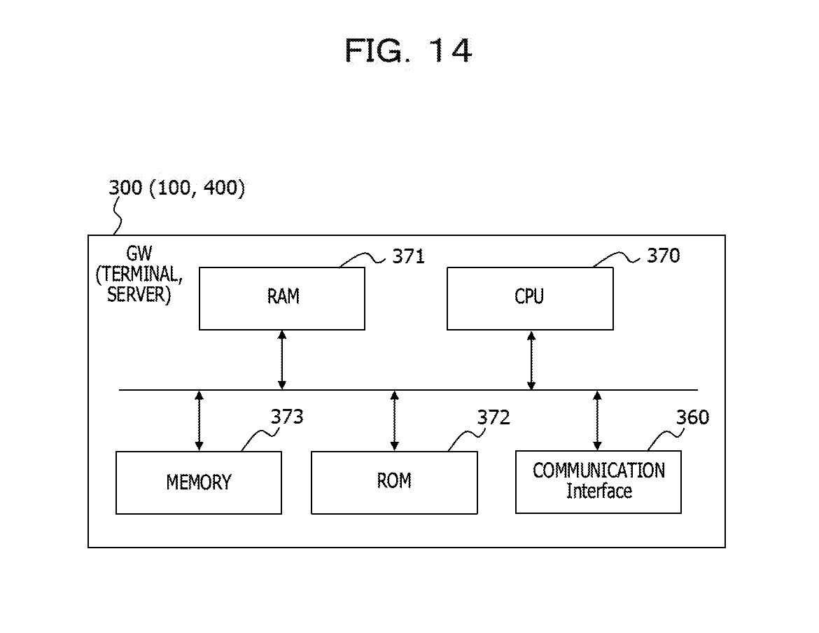

In addition, in the above-mentioned second embodiment, an example in which the congestion control illustrated in FIG. 9 and the FIG. 12 is performed by the GW 300 is described. The congestion control may be performed in, for example, the terminal 100 or the server 400. In this case, an example of a configuration of, for example, each of the terminal 100 and the server 400 is illustrated in FIG. 14. A central processing unit (CPU) 370 reads and loads, into a random access memory (RAM) 371, a program stored in a read only memory (ROM) 372 and executes the loaded program, thereby performing the function of the TCP proxy 330. From this, in the terminal 100 or the server 400, it is possible to perform the functions of the congestion window managers 331-1 and 331-2 and the TCP session managers 333-1 to 333-5, performed by the GW 300. In this case, the terminal 100 exchanges wireless signals with the base stations 200-1 and 200-2 by using a communication interface 360 and extracts data, control signals, and so forth from wireless signals. In addition, the server 400 exchanges predetermined packets with the GW 300 by using the communication interface 360 and extracts data and so forth from packets. The extracted data and so forth are output to the CPU 370, a memory 373, and so forth.

Furthermore, in the above-mentioned second embodiment, an example in which the GW 300 performs the congestion control (in, for example FIG. 9 and FIG. 12) on a TCP session set with the terminal 100 is described. The GW 300 may perform the congestion control (in, for example, FIG. 9 and FIG. 12) on the server 400 or may perform the congestion control on another communication device.

Furthermore, in the above-mentioned second embodiment, there is described an example in which the congestion window of a new TCP session is increased in a case where a reception acknowledgement response is received in an existing TCP session. In addition, in the above-mentioned second embodiment, there is described an example in which the congestion window of an existing TCP session is decreased in a case where a packet loss is detected in a new TCP session.

In a case where a reception acknowledgement response is received in, for example, the first TCP session, the congestion window of the second TCP session may be increased. The TCP session “X” in FIG. 10 corresponds to the first TCP session, and the TCP session Y therein corresponds to the second TCP session. This inhibits the congestion window of the first TCP session from being increased in a case where the congestion window of the first TCP session is larger than that of the second TCP session at a time of reception of a reception acknowledgement response in, for example, the relevant first TCP session, regardless of whether being a new TCP session or an existing TCP session. In this case, the congestion window of the second TCP session is increased. This is performed from the standpoint of fairness that the entire bandwidth of a bearer is to be fairly used by the 2 TCP sessions. The congestion window of the second TCP session is increased, and the congestion window of the first TCP session is not increased. Accordingly, the congestion windows of the 2 TCP sessions come close to the same value, and it becomes possible for the 2 TCP sessions to fairly use a band.

In addition, in a case where a packet loss is detected in, for example, the first TCP session, the congestion window of the second TCP session may be decreased. The TCP session “X” in FIG. 13 corresponds to the first TCP session, and the TCP session “Y” therein corresponds to the second TCP session. In this case, the congestion window of the first TCP session is inhibited from being decreased in a case where the congestion window of the first TCP session is smaller than that of the second TCP session at a time of detection of a packet loss in, for example, the relevant first TCP session, regardless of whether being a new TCP session or an existing TCP session. In this case, the congestion window of the second TCP session is decreased. The congestion window of the second TCP session is decreased while the congestion window of the first TCP session is not decreased. Therefore, in this case, the 2 TCP sessions come close to the same value, and it becomes possible for the 2 TCP sessions to fairly use a band within the entire band of a bearer.

Any one of the cases is able to be implemented in the same way in a case where 3 or more TCP sessions exists. In addition, in the former case, a TCP session having a minimum congestion window is selected as the second TCP session, and in the latter case, a TCP session having a maximum congestion window is selected as the second TCP session. The selection operations are the same as S15 in FIG. 9 and S35 in FIG. 12 in the above-mentioned second embodiment.

FIG. 14 illustrates an example of a hardware configuration of the GW 300. The GW 300 includes the CPU 370, the RAM 371, the ROM 372, and the memory 373. The CPU 370 reads and loads, into the RAM 371, a program stored in the ROM 372 and executes the loaded program, thereby performing the functions of the local P-GW 310 and the TCP proxy 330. The CPU 370 corresponds to, for example, the local P-GW 310 and the TCP proxy 330 in the second embodiment. In addition, the CPU 370 corresponds to, for example, the congestion window managers 331-1 and 331-2 and the TCP session managers 333-1 to 333-5 in the second embodiment.

Note that regarding the CPU 370 illustrated in FIG. 14, a controller such as a micro processing unit (MPU) or a field programmable gate array (FPGA) may be used in place of the CPU 370.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay device comprising:
a memory; and
a processor coupled to the memory and the processor configured to:
perform communication of a packet with a communication device via a first communication session;
perform communication of a packet with the communication device via a second communication session established before the first communication session; and
perform a first control or a second control for the first communication session and the second communication session, the first control including decreasing a bandwidth of the second communication session when a packet loss is detected in the first communication session, the second control including increasing a bandwidth of the first communication session when a reception acknowledgement response for transmission of the packet is detected in the second communication session.

2. The relay device according to claim 1, wherein
the first communication session is in a state of exponentially increasing a bandwidth from a minimum value until a packet loss occurs, and the second communication session is in a state of linearly increasing a bandwidth from a threshold value until a packet loss occurs.

3. The relay device according to claim 1, wherein
the processor is further configured to:
perform the first control when the bandwidth of the second communication session is greater than or equal to a bandwidth of the first communication session.

4. The relay device according to claim 1, wherein
the processor is further configured to:
perform the second control when a bandwidth of the second communication session is greater than the bandwidth of the first communication session.

5. The relay device according to claim 1, wherein
the processor is further configured to:
when a plurality of second communication sessions is established, perform the first control for one of the plurality of second communication sessions of which the bandwidth is a maximum bandwidth among the plurality of second communication sessions.

6. The relay device according to claim 1, wherein
the processor is further configured to:
when a plurality of first communication sessions is established, perform the second control for one of the plurality of first communication sessions of which the bandwidth is a minimum bandwidth among the plurality of first communication sessions.

7. The relay device according to claim 1, wherein
the processor is further configured to:
decrease a bandwidth of the first communication session when the second communication session is not established or when the bandwidth of the first communication session is greater than the bandwidth of the second communication session.

8. The relay device according to claim 1, wherein
the processor is further configured to:
increase a bandwidth of the second communication session when the first communication session is not established or when the bandwidth of the first communication session is greater than or equal to the bandwidth of the second communication session.

9. The relay device according to claim 1, wherein
the first communication session and second communication session are transmission control protocol (TCP) sessions.

10. The relay device according to claim 1, wherein
the processor is configured to
increase a bandwidth of the second communication session when the reception acknowledgement response for transmission of the packet is detected in the second communication session and when the first communication session is not established; and
increase the bandwidth of the first communication session instead of the bandwidth of the second communication session when the reception acknowledgement response for transmission of the packet is detected in the second communication session after the first communication session is established.

11. A relay method executed by a relay device, the relay method comprising:
performing communication of a packet with a communication device via a first communication session;
performing communication of a packet with the communication device via a second communication session established before the first communication session; and
performing a first control or a second control for the first communication session and the second communication session, the first control including decreasing a bandwidth of the second communication session when a packet loss is detected in the first communication session, the second control including increasing a bandwidth of the first communication session when a reception acknowledgement response for transmission of the packet is detected in the second communication session.

12. A relay device that performs transmission control on a first transmission control protocol (TCP) session and a second TCP session, the relay device comprising:
a memory; and
a processor coupled to the memory and the processor configured to:
perform a first control or a second control for the first TCP session and the second TCP session, the second TCP session being established before the first TCP session, the first control including decreasing a bandwidth of the second TCP session when a packet loss is detected in the first TCP session, the second control including increasing a bandwidth of the first TCP session when a reception acknowledgement response for transmission of the packet is detected in the second TCP session.
